(19) United States
(12) Patent Application Publication
(10) Pub. No.: US 2026/0007178 A1
(43) Pub. Date: Jan. 8, 2026

(54) VAPORIZING APPARATUS AND SYSTEM

(71) Applicant: Ben Bartell, Maple Valley, WA (US)

(72) Inventor: Ben Bartell, Maple Valley, WA (US)

(21) Appl. No.: 18/762,622

(22) Filed: Jul. 2, 2024

(51) Int. Cl. A24F 40/48; A24F 1/30; A24F 7/00; A24F 40/10; A24F 40/46; H05B 3/03

(52) U.S. Cl. CPC A24F 40/48; A24F 7/00; A24F 40/10; A24F 40/46; H05B 3/03; A24F 1/30

(57) ABSTRACT

Embodiments of the present disclosure include an apparatus. The apparatus includes an atomizer, a container positioned adjacent to and fluidly connected to the atomizer, and a base unit positioned adjacent to the container and the atomizer. The base unit includes a receptacle. The atomizer also includes a channel and an opening to the channel. The opening is positioned between the atomizer and the container and configured to, with the channel, fluidly connect the container to the receptacle.

### FIELD

This disclosure relates generally to vaporization, and more particularly to vaporization apparatus and systems.

### BACKGROUND

Vaporizers can be used to heat substances such as concentrates to convert such substances to vapor using an open flame and/or electric elements. Concentrates can include substances to be ingested, inhaled, and/or smoked in vapor form. Vaporizers can provide a healthier, safer, and/or more customizable alternative to other devices designed for consumption of such substances.

### SUMMARY

The subject matter of the present application has been developed in response to the present state of the art, and in particular, in response to the shortcomings of vaporizing apparatuses and systems, that have not yet been fully solved by currently available techniques. Accordingly, the subject matter of the present application has been developed to provide vaporizing apparatuses and systems that overcome at least some of the above-discussed shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, an apparatus includes an atomizer, a container positioned adjacent to and fluidly connected to the atomizer, and a base unit positioned adjacent to the container and the atomizer. The base unit includes a receptacle. The atomizer also includes a channel and an opening to the channel. The opening is positioned between the atomizer and the container and configured to, with the channel, fluidly connect the container to the receptacle.

The following portion of this paragraph delineates example 2 of the subject matter, disclosed herein. According to example 2, which encompasses example 1, above, the opening is a first opening, and the channel is a first channel. The vaporizer further includes a second channel fluidly connecting the atomizer to the container. The atomizer includes a second opening.

The following portion of this paragraph delineates example 3 of the subject matter, disclosed herein. According to example 3, which encompasses any of examples 1-2, above, the atomizer further includes a heating element configured to heat a substance received through the second opening to produce a vapor that flows through the second channel and into the container and subsequently flows out of the container and into the receptacle via the first channel.

The following portion of this paragraph delineates example 4 of the subject matter, disclosed herein. According to example 4, which encompasses any one of examples 1-3, above, the container is positioned such that a first of the vapor remains in the container while a second portion of the vapor flows out of the container via the first channel.

The following portion of this paragraph delineates example 5 of the subject matter, disclosed herein. According to example 5, which encompasses any one of examples 1-4, above, the heating element includes at least one of: a metallic material, a ceramic material, a crystalline material, and/or any combination thereof. The base unit includes a power supply configured to supply power to the heating element.

The following portion of this paragraph delineates example 6 of the subject matter, disclosed herein. According to example 6, which encompasses any one of examples 1-5, above, the first channel extends substantially perpendicular to the second channel and the container extends substantially parallel to the second channel.

The following portion of this paragraph delineates example 7 of the subject matter, disclosed herein. According to example 7, which encompasses any one of examples 1-6, above, the apparatus includes a housing configured to be coupled to the container and disposed around at least a portion of the atomizer to enclose at least a portion of the second channel.

The following portion of this paragraph delineates example 8 of the subject matter, disclosed herein. According to example 8, which encompasses any one of examples 1-7, above, the apparatus includes a third channel fluidly connecting the container to the first channel. The atomizer is fluidly closed with respect to the third channel.

The following portion of this paragraph delineates example 9 of the subject matter, disclosed herein. According to example 9, which encompasses any one of examples 1-8, above, a space between an interior surface of the housing and an exterior surface of the second channel defines the third channel.

The following portion of this paragraph delineates example 10 of the subject matter, disclosed herein. According to example 10, which encompasses any one of examples 1-9, above, the container includes a first end configured to be coupled to the housing and a second end opposite to the first end. The first end is coupled to the housing. The second end is positioned between, in a direction substantially parallel to the second channel, the first opening and an end of the base unit.

The following portion of this paragraph delineates example 11 of the subject matter, disclosed herein. According to example 11, which encompasses any one of examples 1-10, above, a length of the container, from the first end to the second end, is substantially parallel to a length of the base unit.

The following portion of this paragraph delineates example 12 of the subject matter, disclosed herein. According to example 12, which encompasses any one of examples 1-11, above, the first channel is defined by a housing channel within the housing and a base unit channel within the base unit. The base unit is fixedly coupled to the housing such that the housing channel and the base unit channel are substantially aligned.

The following portion of this paragraph delineates example 13 of the subject matter, disclosed herein. According to example 13, which encompasses any one of examples 1-12, above, the container is substantially concentric with respect to the atomizer and with respect to the second channel.

The following portion of this paragraph delineates example 14 of the subject matter, disclosed herein. According to example 14, which encompasses any one of examples 1-13, above, the container is positioned laterally apart from the atomizer in a first direction and the atomizer and the container are each offset laterally from the base unit in a second direction substantially perpendicular to the first direction.

The following portion of this paragraph delineates example 15 of the subject matter, disclosed herein. According to example 15, which encompasses any one of examples 1-14, above, the container is made of glass.

The following portion of this paragraph delineates example 16 of the subject matter, disclosed herein. According to example 16, which encompasses any one of examples 1-15, above, the receptacle is configured to receive a mouthpiece and the opening is configured to, with the channel, fluidly connect the container to the mouthpiece when the mouthpiece is received by the receptacle.

The following portion of this paragraph delineates example 17 of the subject matter, disclosed herein. According to example 17, a system includes a mouthpiece and a vaporizer. The vaporizer includes an atomizer, a container positioned adjacent to and fluidly connected to the atomizer, and a base unit positioned adjacent to the container and the atomizer. The base unit is coupled to the mouthpiece. The vaporizer also includes a channel and an opening to the channel. The opening is positioned between the atomizer and the container and is configured to, with the channel, fluidly connect the container to the mouthpiece.

The following portion of this paragraph delineates example 18 of the subject matter, disclosed herein. According to example 18, which encompasses example 17, above, the opening is a first opening and the mouthpiece includes a second opening allowing vapor to flow from the container, through the channel, into the mouthpiece via the first opening, and out of the mouthpiece via the second opening.

The following portion of this paragraph delineates example 19 of the subject matter, disclosed herein. According to example 19, which encompasses any of examples 17-18, above, the mouthpiece further includes a third opening positioned to be substantially aligned with the opening when the mouthpiece is coupled to the base unit.

The following portion of this paragraph delineates example 20 of the subject matter, disclosed herein. According to example 20, a method includes coupling an atomizer to a container such that the container is adjacent to and fluidly connected to the atomizer. The coupling includes disposing a housing around at least a portion of the atomizer and coupling the container to the housing. The method also includes fluidly connecting a receptacle of a base unit to the container via an opening positioned between the atomizer and the container and a channel fluidly connecting the opening to the receptacle. The base unit is positioned adjacent to the container and the atomizer.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A illustrates a front view of a vaporizing system, according to one or more examples of the present disclosure;

FIG. 1B illustrates a cross-sectional view of a vaporizing system, according to one or more examples of the present disclosure;

FIG. 2A illustrates a top perspective view of a vaporizing system, according to one or more examples of the present disclosure;

FIG. 2B illustrates a front view of a vaporizing system, according to one or more examples of the present disclosure;

FIG. 2C illustrates a side view of a vaporizing system, according to one or more examples of the present disclosure;

FIG. 2D illustrates another side view of a vaporizing system, according to one or more examples of the present disclosure;

FIG. 2E illustrates a top view of a vaporizing system, according to one or more examples of the present disclosure;

FIG. 2F illustrates a bottom view of a vaporizing system, according to one or more examples of the present disclosure;

FIG. 3 illustrates a schematic block diagram of a vaporizing apparatus, according to one or more embodiments of the present disclosure; and

FIG. 4 illustrates a schematic flow chart of a method, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Vaporizers can be used to convert received substances into a vapor that can be inhaled. Such substances include, for example, oils and/or liquids that can be heated to produce a vapor. As used herein, the term “vaporizer” includes any one of a vaporizing apparatus (e.g., vaporizing apparatus 102), a vaporizing system (e.g., vaporizing system 100), an electric dab ring, and/or any combination thereof.

Vaporizers can convert a received substance into a vapor by heating the substance. The vapor can then flow into a mouthpiece for inhalation by the user. Vaporizers can often be difficult to clean due to condensation from the vapor that accumulates in the mouthpiece. As such, the present disclosure includes examples of vaporizers designed to help reduce health risks and facilitate cleaning.

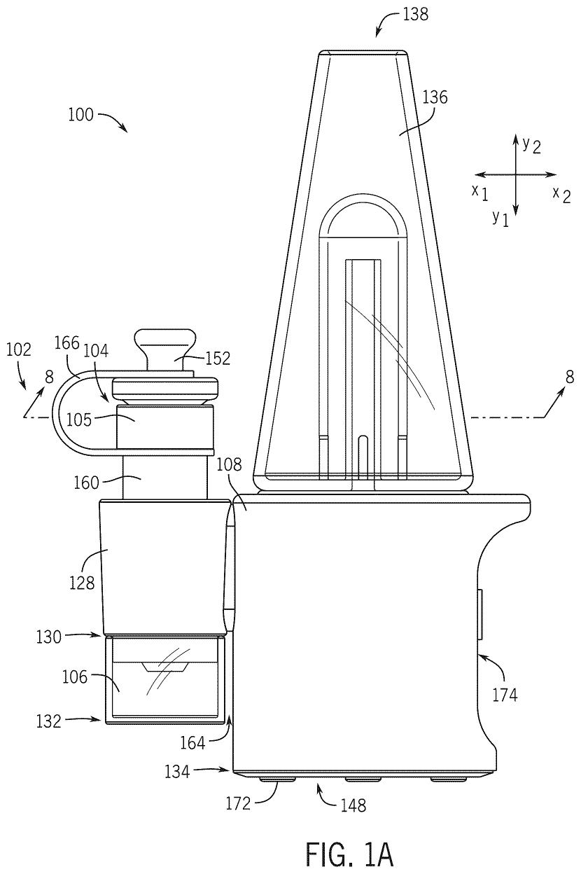

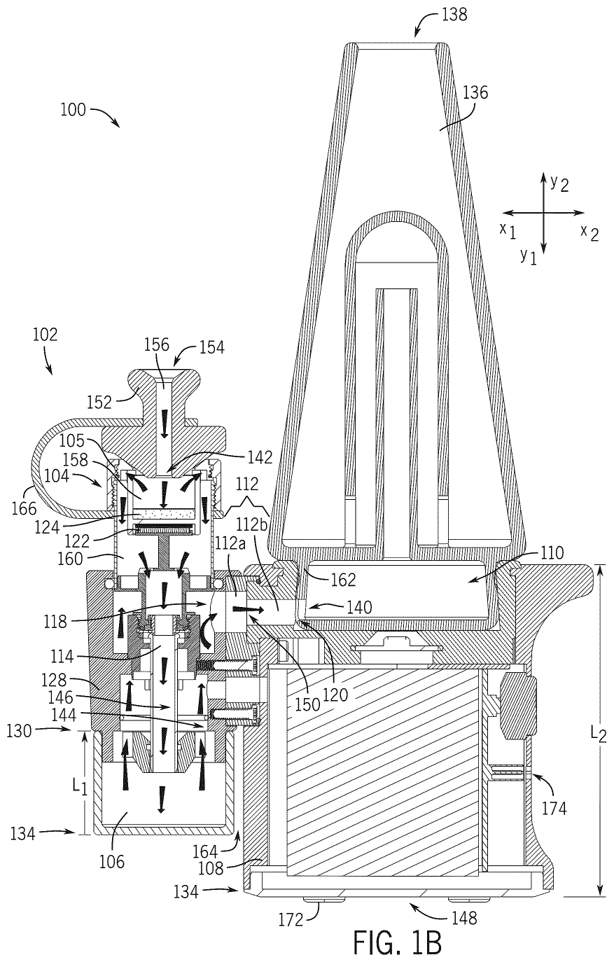

FIG. 1A illustrates a front view of a vaporizing system 100, according to one or more examples of the present disclosure. As shown in FIG. 1A, in some examples, the vaporizing system 100 includes a vaporizer 102 and a mouthpiece 136. As shown in FIGS. 1A-B, in some examples, the vaporizer 102 includes an atomizer 104, a container 106, and a base unit 108. In some examples, the container 106 is fluidly connected to the atomizer 104. In some examples, the mouthpiece 136 is received by the base unit 108 and is fluidly connected to the container 106. FIG. 1B shows a cross-sectional view of the vaporizing system 100 of FIG. 1A in a plane ‘8.’

As used herein, the term “atomizer” includes any device configured to reduce at least a portion of a liquid and/or oil to a vapor. As shown in FIG. 1B, in some examples, the atomizer 104 is configured to receive a substance 124 to be converted to a vapor. In some examples, a received substance 124 includes at least one of: cannabis, cannabis concentrate, cannabidiol, Rick Simpson Oil (“RSO”), hemp, hash, tetrahydrocannabinol oil, essential oils, vegetable glycerin, propylene glycol, flavoring, nicotine, distilled water, alcohol, wax concentrates, and/or any combination thereof.

In some examples, the atomizer 104 is an atomizer assembly that includes one or more of: a heating element 122, an atomizer receptacle 158, an atomizer container 160, and/or a coupling element 105. In various examples, the atomizer 104 includes an opening 142 through which the atomizer 104 receives the substance 124. As shown in FIGS. 1A-B, in some examples, the vaporizing system 100 includes a cap 152 positioned over the opening 142. In some examples, the cap 152 is configured to help prevent vapor from escaping the atomizer 104 so that a high percentage of the vapor is inhaled through the mouthpiece 136. In some examples, the cap 152 forms a partial seal with the atomizer 104 and/or covers the opening 142. In some examples, the cap 152 is removable. In some examples, the cap 152 includes an opening 154 through which air can flow into the atomizer 104. In some examples, the cap opening 154 is substantially aligned with the atomizer opening 142. In some examples, the cap 152 also includes a cap channel 156 that extends from the cap opening 154 to the atomizer opening 142. In some examples, the cap 152 is attached to the vaporizer 102 via a flexible member 166. In some examples, the flexible member 166 is looped around the atomizer 104. In some examples, the cap 152 can be removed from the atomizer 104 while remaining indirectly attached to the vaporizer 102 via the flexible member 166.

In various examples, the atomizer 104 includes a heating element 122, and the atomizer 104 then heats the substance 124 via the heating element 122 to produce a vapor. In some examples, the atomizer 104 includes an atomizer receptacle 158 that is fluidly open to and positioned within an atomizer container 160 of the atomizer 104. In some examples, the atomizer receptacle 158 is fluidly open to the atomizer opening 142. In some examples, the heating element 122 is positioned at and/or in the base of the atomizer receptacle 158. In such examples, the received substance is received into the atomizer receptacle 158 and heated via the heating element 122. In various examples, the vapor produced by heating the received substance then flows upward and out of the atomizer receptacle 158 but within the atomizer container 160. In some examples, the atomizer receptacle 158 includes at least one of: a bowl, container, or any combination thereof. In some examples, the atomizer receptacle 158 has a smaller diameter than the atomizer container 160. In some examples, the atomizer receptacle 158 is made of a thermally conductive material. In some examples, the atomizer receptacle 158 is made of quartz.

In some examples, the coupling element 105 is configured to couple the atomizer receptacle 158 to the atomizer container 160. In some examples, the coupling element 105 couples the atomizer receptacle 158 to the atomizer container 160 indirectly. In some examples, the coupling element 105 includes a ring with a portion configured to fit around the atomizer container 160 and a portion of a different dimension configured to couple to the atomizer receptacle 158. In some examples, the coupling element 105 includes one or more threaded portions configured to mate with one or more threaded portions of an exterior surface of the atomizer container 160.

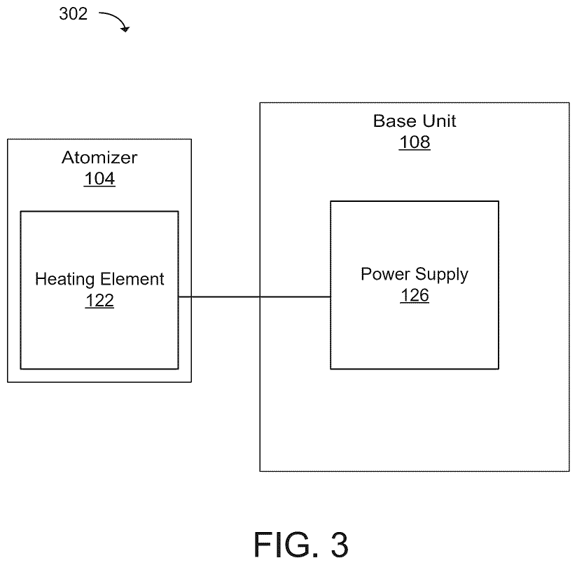

In some examples, the heating element 122 is made of at least one of the following materials: a metallic material, a ceramic material, a crystalline material, and/or any combination thereof. In some examples, the heating element 122 includes a heated plate. As shown in FIG. 3, in one or more examples, the heating element 122 is powered by a power supply 126 in the base unit 108.

In some examples, the vapor formed by the heating element 122 flows out of the atomizer receptacle 158 (e.g., by flowing upward over the edges of the atomizer receptacle 158 and then downward towards the second channel 114). In some examples, the atomizer container 160 is fluidly connected to the container 106. In some examples, the vapor flows into the container 106 after flowing out of the atomizer receptacle 158. In some examples, the container 106 is positioned adjacent to and fluidly connected to the atomizer 104. In some examples, the container 106 is positioned below the atomizer 104. In some examples, the container 106 is displaced from the atomizer 104 in a direction y1. In some examples, the container 106 is also adjacent to the base unit 108. In some examples, the container 106 is spaced apart from the base unit 108 laterally in a direction x1 that is substantially perpendicular to the direction y1. In some examples, the atomizer 104 is also offset from the base unit 108 in the direction x1.

In some examples, the vaporizer 102 includes one or more of a first channel 112, a second channel 114, and a third channel 116. In some examples, the container 106 is fluidly connected to the atomizer 104 via the second channel 114. In some examples, the vapor enters the second channel 114 from the atomizer container 160 and flows down into the container 106.

In some examples, the container 106 is made of a transparent and/or translucent material. In some examples, the container 106 is made of glass. In some examples, the container 106 is substantially concentric with respect to the atomizer 104 and/or with respect to the second channel 114.

In various examples, a portion of the vapor remains in the container 106 and condenses on the surfaces of the container 106, while another portion of the vapor flows upward to be inhaled via a mouthpiece 136. In some examples, the positioning of the container 106 can help to reduce condensation in the mouthpiece 136, thus helping to reduce risk of insanitary inhalation for the user.

In some examples, the container 106 can be cleaned to remove the condensed vapor. In various examples, the container 106 is removably coupled to a housing 128 of the vaporizer 102, and the housing 128 is fixedly coupled to the base unit 108. As shown in FIG. 1B, in some examples, the housing 128 encloses at least a portion of the second channel 114. In various examples, the container 106 is indirectly coupled to the atomizer 104 via the housing 128. In one or more examples, the container 106 is removable from the housing 128. Such examples can help to facilitate cleaning by allowing a user to remove the container 106 to clean the condensed vapor from the interior surfaces of the container 106. In some examples, the container 106 and the housing 128 include threaded portions and/or other types of portions configured to mate with each other. As shown in FIGS. 1A-B, in some examples, the housing 128 is disposed around at least a portion of the atomizer 104.

In some examples, the container 106 is configured to be coupled to the housing 128 at a first end 130 of the container 106. In various examples, the container 106 includes a second end 132 opposite to the first end 130. In some examples, when the first end 130 is coupled to the housing 128, the second end 132 is positioned between the first opening 118 and a base 148 of the base unit 108. In such examples, the container 106 is configured to be suspended above a surface when the base unit 108 is placed on the surface.

In some examples, a portion of the vapor flows out of the container 106 and into the receptacle 110 via the first channel 112 and/or the third channel 116. In some examples, the third channel 116 fluidly connects the container 106 to the first channel 112. In one or more examples, the portion of the vapor flows in the direction y2 through the third channel 116 until the third channel 116 meets the first channel 112.

In some examples, the third channel 116 is defined by a space between one or more interior surfaces 144 of the housing 128 and an exterior surface 146 of the second channel 114. In various examples, the atomizer 104 is fluidly closed with respect to the third channel 116. As such, the vapor does not flow back up into the atomizer 104 but rather flows into the receptacle 110.

In some examples, the vapor flows in a direction x2 towards the receptacle 110 through the first channel 112. In some examples, the direction x2 is substantially perpendicular to the direction y2. As shown in FIG. 1B, in some examples, the first channel 112 is substantially perpendicular to the second channel 114 and/or the third channel 116. In one or more examples, the first channel 112 is extends in the direction x2, and the second channel 114 and/or the third channel 116 extends in the direction y2. In some examples, the second channel 114 and third channel 116 are substantially parallel to each other. As used herein, the terms “substantially parallel” and “substantially perpendicular” include, but are not limited to, angles within five degrees of parallel and/or perpendicular. For examples, the term “substantially parallel” includes embodiments in which one element extends at an angle that is between and inclusive of −5° and 5° with respect to another element. The term “substantially perpendicular” includes embodiments in which one element extends at an angle that is between and inclusive of 85° and 95° with respect to another element.

In some examples, the vaporizer 102 includes a first channel opening 118 to the first channel 112. In some examples, the first channel opening 118 is positioned between the atomizer 104 and the container 106 in the direction in the direction y2. In some examples, the first channel opening 118 is configured to, with the first channel 112, fluidly connect the container 106 to the receptacle 110.

In some examples, the first channel 112 is defined by a housing channel 112a within the housing 128 and a base unit channel 112b within the base unit 108. In some examples, the base unit 108 is fixedly coupled to the housing 128 in a manner such that the housing channel 112a and the base unit channel 112b are substantially aligned to form the first channel 112. In some examples, the base unit channel 112b is connected to the housing channel 112a via a base unit opening 150 of the base unit 108. In some examples, the base unit opening 150 is substantially aligned in the direction x2 with the first opening 118 and is positioned between the first opening 118 and the second opening 120. In various examples, the vapor flows into the housing channel 112a via the first opening 118, into the base unit channel 112b via the base unit opening 150, and into a receptacle 110 and/or a mouthpiece 136 via a second opening 120 at an end of the first channel 112 that is opposite to the first opening 118.

As shown in FIGS. 1A-B, in some examples, the vaporizing system 100 includes a mouthpiece 136. As used herein, the term “receptacle” includes any portion of the base unit 108 configured to receive a mouthpiece 136. In some examples, the receptacle 110 is a well within the base unit 108. In some examples, the receptacle 110 is configured to, with the first channel 112, fluidly connect the container 106 to the mouthpiece 136 when the mouthpiece 136 is received by the receptacle 110.

In some examples, the vapor then flows into the mouthpiece 136 via a reception opening 140 of the mouthpiece 136. In some examples, the reception opening 140 is positioned to be substantially aligned with the second opening 120 when the mouthpiece 136 is received by the base unit 108. In some examples, the reception opening 140 is positioned at a base 162 of the mouthpiece 136. In some examples, the arrows shown in FIG. 1B represent potential paths for the vapor.

In some examples, the mouthpiece 136 includes an open top and/or an inhalation opening 138. In some examples, the inhalation opening 138 allows vapor to flow out of the mouthpiece 136. In various examples, the user can draw the vapor upwards and out of the mouthpiece inhalation opening 138 by placing their mouth at, around, and/or near the inhalation opening 138 and inhaling. In some examples, the mouthpiece 136 is tapered from an end received by the receptacle 110 to the inhalation opening 138. In some examples, the mouthpiece 136 is removably coupled to the base unit 108. In other examples, the mouthpiece 136 is fixed to the base unit 108.

In some examples, the base unit 108 is positioned adjacent to the container 106 and the atomizer 104. In some examples, the base unit 108 is fixedly coupled to the housing 128. In one or more examples, the base unit 108 and the housing 128 are a monolithic construction.

In some examples, the container 106 extends substantially parallel to the second channel 114 and/or substantially perpendicular to the first channel 112. In some examples, the container 106 is substantially concentric with the second channel 114. In one or more examples, one or more of the container 106, first channel 112, second channel 114, and/or third channel 116 are substantially cylindrical in shape.

In some examples, the length l1 of the container 106, from the first end 130 to the second end 132, is substantially parallel to the length l2 of the base unit 108. In some examples, the length l1 of the container 106 is between and inclusive of 20 and 60 percent of the length l2 of the base unit 108. In some examples, the length l1 of the container 106 is between and inclusive of 20 and 40 percent of the length l2 of the base unit 108. In some examples, a displacement 164 between an outer surface of the base unit 108 and an adjacent outer surface of the container 106 in a direction x1 is greater than 0 and less than 10 centimeters. In some examples, the first channel 112 is substantially perpendicular to both the length l1 of the container 106 and the length l2 of the base unit 108.

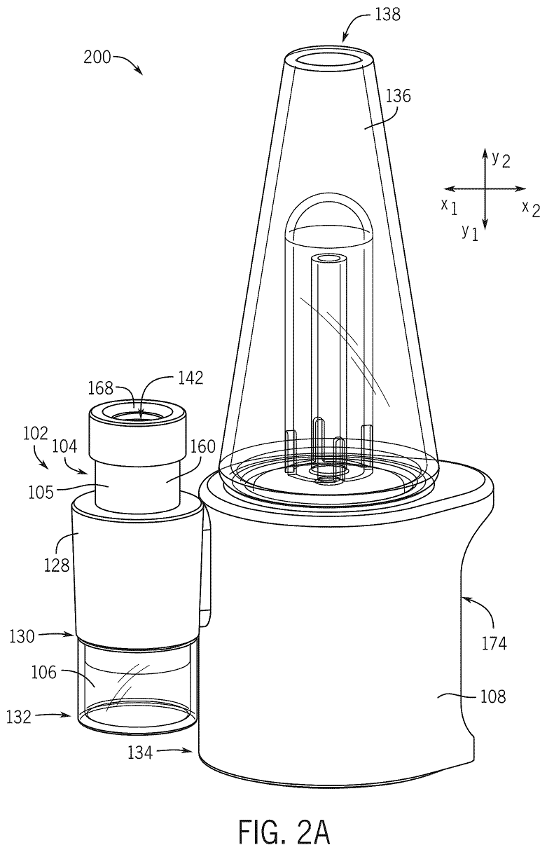

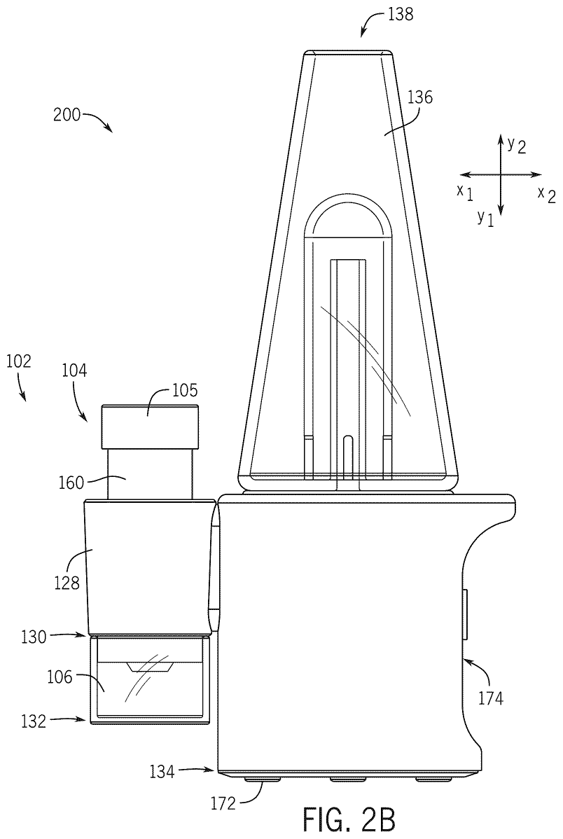

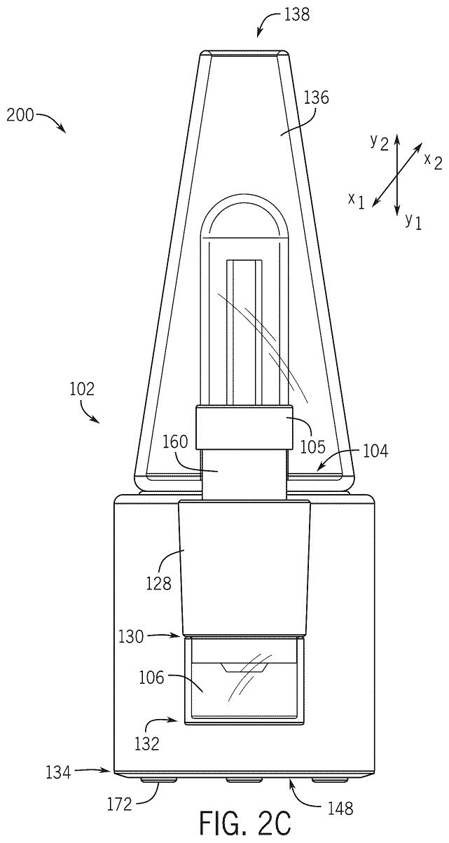

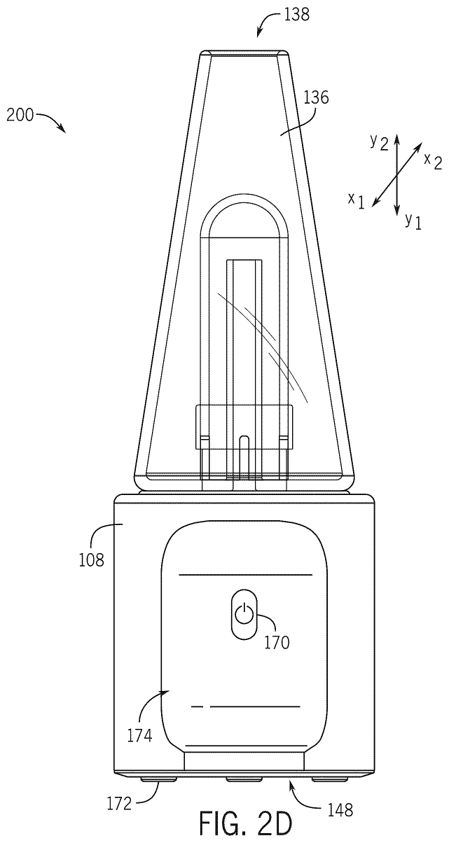

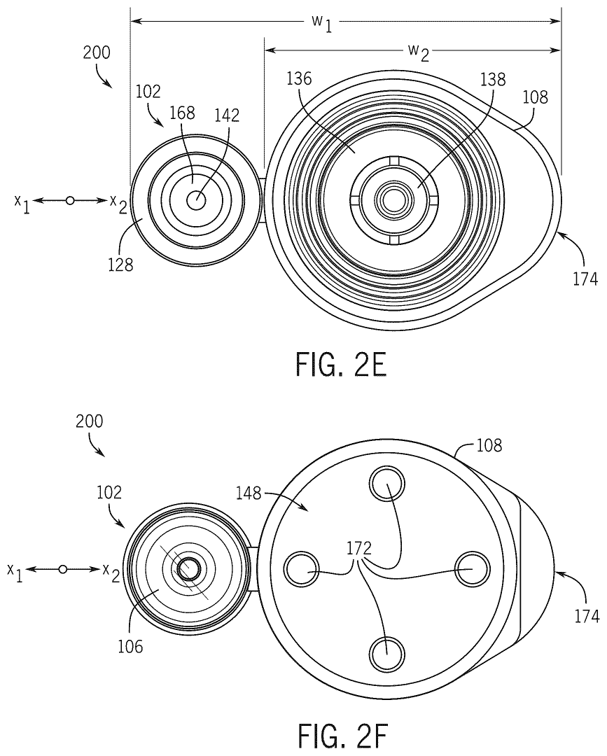

FIG. 2A illustrates a top perspective view of a vaporizing system 200, according to one or more examples of the present disclosure. In some examples, the vaporizing system 200 shown in FIGS. 2A-F is an embodiment of the vaporizing system 100 shown in FIGS. 1A-B.

As shown in FIG. 2A, in some examples, the vaporizing system 100 does not include a cap 152. In one or more examples, the substance 124 enters the atomizer 104 via the atomizer opening 142 directly. In some examples, the atomizer opening 142 is an opening at the base of a funnel 168.

As shown in FIG. 2A, in some examples, the container 106 is made of a transparent material. However, examples of the present disclosure are not so limited. In some examples, the mouthpiece 136 is made of a transparent material, such as glass. However, examples of the present disclosure are not so limited.

In some examples, the mouthpiece 136 is a bubbler. In some examples, the mouthpiece 136 is a water bubbler. In some examples, the mouthpiece 136 and/or the base unit 108 includes a reservoir configured to hold water. In some examples, the mouthpiece 136 is configured to circulate the water such that the vapor is exposed to the water.

As shown in FIG. 2A, in some examples, the vaporizing system 100 is a handheld device. In some examples, the base unit 108 is configured to be gripped by the user. In some examples, the base unit 108 includes a gripping portion 174. In various examples, the base unit 108 includes a handle.

FIG. 2B illustrates a back view of the vaporizing system 200, according to one or more examples of the present disclosure. As shown in FIG. 2B, in some examples, a portion 128a of the housing 128 is visible through the container 106.

FIG. 2C illustrates a side view of the vaporizing system 200, according to one or more examples of the present disclosure. As shown in FIG. 2C, in some examples, one or more of the atomizer 104, housing 128, and/or container 106 are substantially centered, from the side view perspective, with respect to the base unit 108.

FIG. 2D illustrates another side view of the vaporizing system 200, according to one or more examples of the present disclosure. In some examples, the base unit 108 includes a component configured to actuate the power supply 126 in response to user input. In some examples, the base unit 108 includes a user interface configured to receive input from the user. In some examples, the base unit 108 includes a button 170 configured to activate and/or deactivate the power supply 126 to supply power to the heating element 122. In some examples, the base unit 108 includes buttons and/or an adjustable knob configured to adjust the heat produced by the heating element 122 by adjusting the power supplied to the heating element 122.

FIG. 2E illustrates a top view of the vaporizing system 200, according to one or more examples of the present disclosure. As shown in FIG. 2E, in some examples, a total width w1 of the vaporizing system 200 is between and inclusive of 5 and 30 centimeters (“cm”). In some examples, the total width w1 of the vaporizing system 200 is between and inclusive of 5 and 10 cm. In some examples, a total width w2 of the base unit 108 is between and inclusive of 5 and 30 cm. In some examples, the total width w2 of the base unit 108 is between 5 and 10 cm.

FIG. 2F illustrates a bottom view of the vaporizing system 200, according to one or more examples of the present disclosure. As shown in FIG. 2F, in some examples, the base unit 108 includes one or more feet 172 configured to support the base unit 108 as it rests against a surface. As shown in FIGS. 1A-B and 2D, in some examples, the feet 172 elevate the base unit 108 slightly.

FIG. 3 illustrates a schematic block diagram of a vaporizing apparatus 302, according to one or more examples of the present disclosure. In some examples, the vaporizing apparatus 302 is an embodiment of the vaporizing apparatuses 102 and 202 shown in FIGS. 1A-2F.

As shown in FIG. 3, in some examples, the base unit 108 includes a power supply 126 configured to supply power to the atomizer 304. In some examples, the power supply 126 is a battery. In some examples, the power supply 126 is configured to supply power to the heating element 122 through a wired connection. In some examples, the wired connection is at least partially housed by the housing 128.

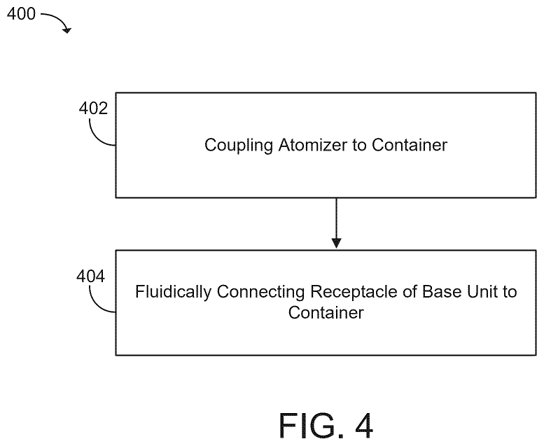

FIG. 4 illustrates a schematic flow chart of a method 400 of constructing a vaporizer 102 and/or vaporizing system 100, according to one or more examples of the present disclosure.

In some examples, the method 400 includes coupling 402 an atomizer 104 to a container 106 such that the container 106 is adjacent to and fluidly connected to the atomizer 104. In some examples, the coupling 402 includes disposing a housing 128 around a portion of the atomizer 104 and coupling the container 106 to the housing 128. In one or more examples, the method 400 includes fluidly connecting 404 a receptacle 110 of a base unit 108 to the container 106 via an opening 118 positioned between the atomizer 104 and the container 106 and a channel 112 connecting the opening 118 to the receptacle 110. In some examples, the base unit 108 is positioned adjacent to the container 106 and the atomizer 104.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” in some embodiments, is defined to mean within +/−5% of a given value, however in additional embodiments any disclosure of “about” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus, comprising:
an atomizer;
a container positioned adjacent to and fluidly connected to the atomizer;
a base unit positioned adjacent to the container and the atomizer and comprising a receptacle;
a channel; and
an opening to the channel, the opening positioned between the atomizer and the container and configured to, with the channel, fluidly connect the container to the receptacle.

2. The apparatus of claim 1, wherein:
the opening comprises a first opening;
the channel comprises a first channel;
the apparatus further comprises a second channel fluidly connecting the atomizer to the container; and
the atomizer comprises a second opening.

3. The apparatus of claim 2, wherein the atomizer further comprises a heating element configured to heat a substance received through the second opening to produce a vapor that flows through the second channel and into the container and subsequently flows out of the container and into the receptacle via the first channel.

4. The apparatus of claim 3, wherein the container is positioned such that a first of the vapor remains in the container while a second portion of the vapor flows out of the container via the first channel.

5. The apparatus of claim 3, wherein:
the heating element comprises at least one of: a metallic material, a ceramic material, a crystalline material, and/or any combination thereof; and
the base unit comprises a power supply configured to supply power to the heating element.

6. The apparatus of claim 2, wherein the first channel extends substantially perpendicular to the second channel and the container extends substantially parallel to the second channel.

7. The apparatus of claim 2, further comprising a housing configured to be coupled to the container and disposed around at least a portion of the atomizer to enclose at least a portion of the second channel.

8. The apparatus of claim 7, further comprising a third channel fluidly connecting the container to the first channel, wherein the atomizer is fluidly closed with respect to the third channel.

9. The apparatus of claim 8, wherein a space between an interior surface of the housing and an exterior surface of the second channel defines the third channel.

10. The apparatus of claim 7, wherein the container comprises:
a first end configured to be coupled to the housing; and
and a second end opposite to the first end, wherein, when the first end is coupled to the housing, the second end is positioned between, in a direction substantially parallel to the second channel, the first opening and an end of the base unit.

11. The apparatus of claim 10, wherein a length of the container, from the first end to the second end, is substantially parallel to a length of the base unit.

12. The apparatus of claim 7, wherein:
the first channel is defined by a housing channel within the housing and a base unit channel within the base unit; and
the base unit is fixedly coupled to the housing such that the housing channel and the base unit channel are substantially aligned.

13. The apparatus of claim 2, wherein the container is substantially concentric with respect to the atomizer and with respect to the second channel.

14. The apparatus of claim 1, wherein the container is positioned laterally apart from the atomizer in a first direction and the atomizer and the container are each offset laterally from the base unit in a second direction substantially perpendicular to the first direction.

15. The apparatus of claim 1, wherein the container is made of glass.

16. The apparatus of claim 1, wherein the receptacle is configured to receive a mouthpiece and the opening is configured to, with the channel, fluidly connect the container to the mouthpiece when the mouthpiece is received by the receptacle.

17. A system, comprising:
a mouthpiece; and
a vaporizer, comprising:
an atomizer;
a container positioned adjacent to and fluidly connected to the atomizer;
a base unit positioned adjacent to the container and the atomizer and coupled to the mouthpiece;
a channel; and
an opening to the channel, the opening positioned between the atomizer and the container and configured to, with the channel, fluidly connect the container to the mouthpiece.

18. The system of claim 17, wherein the opening comprises a first opening and the mouthpiece comprises a second opening allowing vapor to flow from the container, through the channel, into the mouthpiece via the first opening, and out of the mouthpiece via the second opening.

19. The system of claim 17, wherein the mouthpiece further comprises a third opening positioned to be substantially aligned with the opening when the mouthpiece is coupled to the base unit.

20. A method, comprising:
coupling an atomizer to a container such that the container is adjacent to and fluidly connected to the atomizer, wherein the coupling comprises:
disposing a housing around at least a portion of the atomizer; and
coupling the container to the housing; and
fluidly connecting a receptacle of a base unit to the container via an opening positioned between the atomizer and the container and a channel fluidly connecting the opening to the receptacle, wherein the base unit is positioned adjacent to the container and the atomizer.
